(19) United States
(12) Patent Application Publication
(10) Pub. No.: US 2005/0236915 A1
(43) Pub. Date: Oct. 27, 2005

(54) ELECTROMAGNETIC FORCE ACTUATOR

(75) Inventor: Alton H. Phillips, E. Palo Alto, CA (US)

Correspondence Address: BEYER WEAVER & THOMAS LLP, P.O. BOX 70250, OAKLAND, CA, 94612-0250, US

(73) Assignee: Nikon Corporation, Tokyo (JP)

(21) Appl. No.: 10/831,723

(22) Filed: Apr. 23, 2004

(51) Int. Cl. H02K 9/00

(52) U.S. Cl. 310/52

(57) ABSTRACT

An electromagnetic actuator apparatus that utilizes coolant fluid to remove heat generated by the actuator is described. The apparatus includes a solid base plate that is formed to house electrically conductive materials, such as wire loops. The solid base plate is a single piece of material that is formed with embedded channels. The conductive materials are situated within a cavity of the actuator apparatus within which the coolant fluid can flow over and remove heat from the conductive materials. A flow guide having vanes can be inserted into the cavity of an actuator apparatus to guide the flow of coolant fluid to efficiently cool the wire loops. An actuator array that includes multiple actuators is also described.

### FIELD OF THE INVENTION

The present invention relates generally to electromagnetic actuators, and more specifically to techniques for removing heat from electromagnetic actuators.

### BACKGROUND

Electromagnetic actuators involve the interaction between magnets and electrical conductors. These magnets create a magnetic field that flows through the electrical conductors, such as wire loops. A force, such as a Lorentz force, is then created by the interaction between the magnetic field and the current flowing through the wire loops. The forces can then be used to position, move, and/or stabilize mechanical devices, structures, or objects.

Unfortunately, electrical current flowing through electrical conductors during operation of the actuators causes the actuators to generate heat. One technique for removing heat from an actuator involves passing coolant fluids over the heat generating components of an actuator, such as the electrical conductors. Though effective, this cooling technique can cause problems in systems that operate within sensitive operational environments such as photolithography systems, which commonly operate in vacuum environments and require contaminant-free conditions. The problems include coolant fluid leakage, which can contaminate various system components such as semiconductor wafers and reticles, and vacuum pressure loss.

In view of the foregoing, there are continuing efforts to provide improved electromagnetic actuator cooling techniques for use in sensitive operational environments.

### BRIEF SUMMARY OF THE INVENTION

The present invention is directed to an electromagnetic actuator apparatus that utilizes coolant fluid to remove heat generated by the actuator. The apparatus includes a solid base plate that is formed to house electrically conductive materials, such as wire loops. The solid base plate is a single piece of material that is formed with embedded channels. Since the base plate is a solid piece of material, coolant fluid that is provided to flow through the channels is prevented from leaking through the base plate and then possibly damaging other components. The conductive materials are situated within a cavity of the actuator apparatus within which the coolant fluid can flow over and remove heat from the conductive materials. Electromagnetic actuators of the present invention can be used in sensitive operating environments such as within semiconductor manufacturing systems where coolant fluid leakage could be a source of contamination and could cause the loss of an operational vacuum pressure. Ultimately, the electromagnetic actuator apparatus can be used to move, stabilize, shape, and/or position an object that is mounted onto the apparatus.

One aspect of the invention pertains to an electromagnetic motor apparatus that includes a solid base plate having a first surface and an opposing second surface, a rim that extends from the first surface of the base plate wherein the rim is integrally formed with the base plate, a recessed channel formed on the second surface of the base plate, the channel having an inlet end and an outlet end, a cavity formed within the second surface of the base plate, the cavity also extending into the rim such that the rim is substantially hollow, the cavity being connected to the channel whereby a fluid can enter the channel at the inlet end, flow through the channel and the cavity, and then exit the channel at the outlet end, and a plurality of conductive wires positioned within the cavity whereby the fluid can pass over the wires and thereby remove heat from the wires.

One embodiment of the electromagnetic motor apparatus further includes a pair of magnets positioned adjacent to the first surface of the base plate and such that the rim is positioned between the pair of magnets whereby the pair of magnets create a magnetic field that passes through the rim and the conductive wires.

Another embodiment of the electromagnetic motor apparatus further includes a flow guide that fits within the cavity, the flow guide including a tube-shaped shell with a plurality of vanes that extend from an inner surface of the shell in a radial direction towards the center of the shell, each vane also extending along the longitudinal axis of the shell, whereby the flow guide guides the flow of fluid throughout the volume of the cavity.

An alternative embodiment of the electromagnetic motor apparatus includes a solid base plate having a first surface and an opposing second surface, a plurality of rims that extend from the first surface of the base plate wherein each rim is integrally formed with the base plate, a plurality of recessed channels formed on the second surface of the base plate, each channel having an inlet end and an outlet end, a plurality of cavities formed within the second surface of the base plate, each cavity extending into a respective rim such that each rim is substantially hollow, each cavity being connected to one of the channels whereby a fluid can enter one of the channels at the inlet end, flow through the channel and one of the cavities, and then exit the channel at the outlet end, and a plurality of conductive wires positioned within each cavity whereby the fluid can pass over the wires and thereby remove heat from the wires.

One embodiment of the electromagnetic motor apparatus further includes a plurality of magnet pairs that include a first and a second magnet, each first magnet positioned within the shaft of a respective rim, and each second magnet having a tube shape that is positioned around a respective tube-shaped rim wherein the diameter of the second magnets is larger than the diameter of the rims, each magnet pair creating a magnetic field that passes through a respective rim and conductive wires, whereby a force is created by the interaction between a current that runs through the conductive wires and the magnetic field thereby causing movement between each magnet pair and each respective rim.

Another embodiment of the electromagnetic motor apparatus further includes a plurality of flow guides wherein each flow guide fits within a respective cavity, each flow guide including a tube-shaped shell with a plurality of vanes that extend from an inner surface of the shell in a radial direction towards the center of the shell, each vane also extending along the longitudinal axis of the shell, whereby each flow guide guides the flow of fluid throughout the volume of the cavity.

Another embodiment of the invention pertains to a lithography system that includes an illumination source, an optical system, a reticle stage arranged to retain a reticle, a working stage arranged to retain a workpiece, an enclosure that surrounds at least a portion of the working stage, the enclosure having a sealing surface, and an electromagnetic motor apparatus that includes, a solid base plate having a first surface and an opposing second surface, a plurality of rims that extend from the first surface of the base plate wherein each rim is integrally formed with the base plate, a plurality of recessed channels formed on the second surface of the base plate, each channel having an inlet end and an outlet end, a plurality of cavities formed within the second surface of the base plate, each cavity extending into a respective rim such that each rim is substantially hollow, each cavity being connected to one of the channels whereby a fluid can enter one of the channels at the inlet end, flow through the channel and one of the cavities, and then exit the channel at the outlet end, and a plurality of conductive wires positioned within each cavity whereby the fluid can pass over the wires and thereby remove heat from the wires.

These and other features and advantages of the present invention will be presented in more detail in the following specification of the invention and the accompanying figures, which illustrate by way of example the principles of the invention.

### BRIEF DESCRIPTION OF THE DRAWINGS

The invention, together with further advantages thereof, may best be understood by reference to the following description taken in conjunction with the accompanying drawings in which:

FIGS. 1 and 2 illustrate perspective views of a base plate and a magnet assembly, respectively, wherein the base plate and the magnet assembly, together, form an actuator device when mated together.

FIG. 3 illustrates a cross-sectional view of the actuator device of FIG. 1 along line 3-3 when the base plate and the magnet assembly are mated with each other.

FIG. 4 illustrates a perspective view of the base plate of FIG. 1 from the underside.

FIGS. 5A and 5B illustrate perspective views of a flow guide along two different angles.

FIG. 6 illustrates the flow guide of FIGS. 5A and 5B in its unrolled configuration after being “cut open” along line 6-6 as seen in FIG. 5A.

FIG. 7 illustrates the flow guide of FIGS. 5A and 5B after it has been inserted into a cavity of the actuator device.

FIG. 8 illustrates a perspective view of a top surface of an actuator array.

FIG. 9 illustrates a bottom plan view of a bottom surface of the actuator array of FIG. 8.

FIG. 10 illustrates a side plan view of an actuator system that includes a workpiece that is attached to a vertical electromagnetic actuator array and a horizontal electromagnetic actuator array according to one embodiment of the invention.

FIG. 11 illustrates a top plan view of the actuator system of FIG. 10.

FIG. 12 illustrates a side plan, cross-sectional view of an actuator device according to an alternative embodiment of the present invention.

FIG. 13 illustrates the actuator device of FIG. 3 wherein wires are wrapped along both the inner and outer walls of the cavity.

FIG. 14 illustrates a perspective view of a flow guide according to an alternative embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

The present invention pertains to an electromagnetic actuator apparatus that utilizes coolant fluid to remove heat generated by the actuator. The apparatus includes a solid base plate that is formed to house electrically conductive materials, such as wire loops. The solid base plate is a single piece of material that is formed with embedded channels. Since the base plate is a solid piece of material, coolant fluid that is provided to flow through the channels is prevented from leaking through the base plate and then possibly damaging other components. The conductive materials are situated within a cavity of the actuator apparatus within which the coolant fluid can flow over and remove heat from the conductive materials. The base plate is shaped so that magnets can interact with the conductive materials housed within the base plate. Electromagnetic actuators of the present invention can be used in sensitive operating environments such as within semiconductor manufacturing systems where coolant fluid leakage could be a source of contamination and can cause the loss of an operational vacuum pressure. Ultimately, the electromagnetic actuator apparatus can be used to move, stabilize, shape, and/or position an object that is mounted onto the apparatus.

Some embodiments of an electromagnetic actuator apparatus of the present invention can include multiple actuators that are connected to a mechanical device or structure. In one implementation, a mirror is mounted onto the actuator apparatus. Each actuator can operate to deform the mirror in a specific sub-region in order to shape the mirror with very fine accuracy. Such actuators can also be coordinated with each other to control the orientation of the mirror.

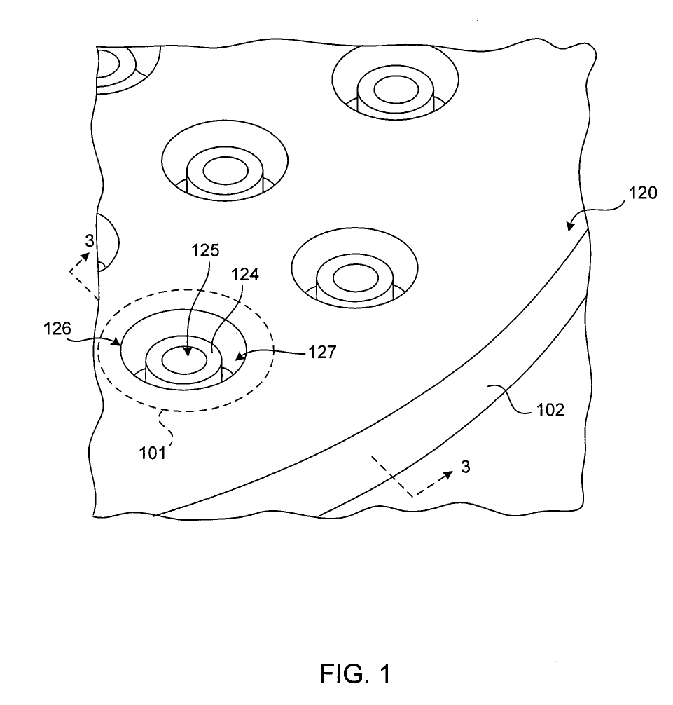

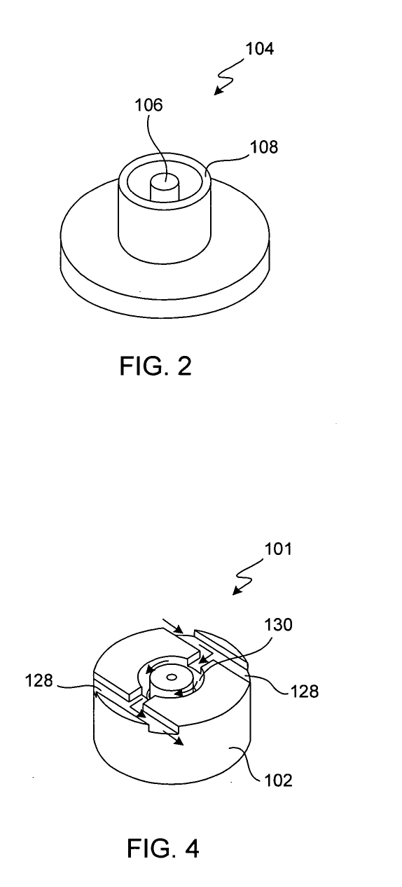

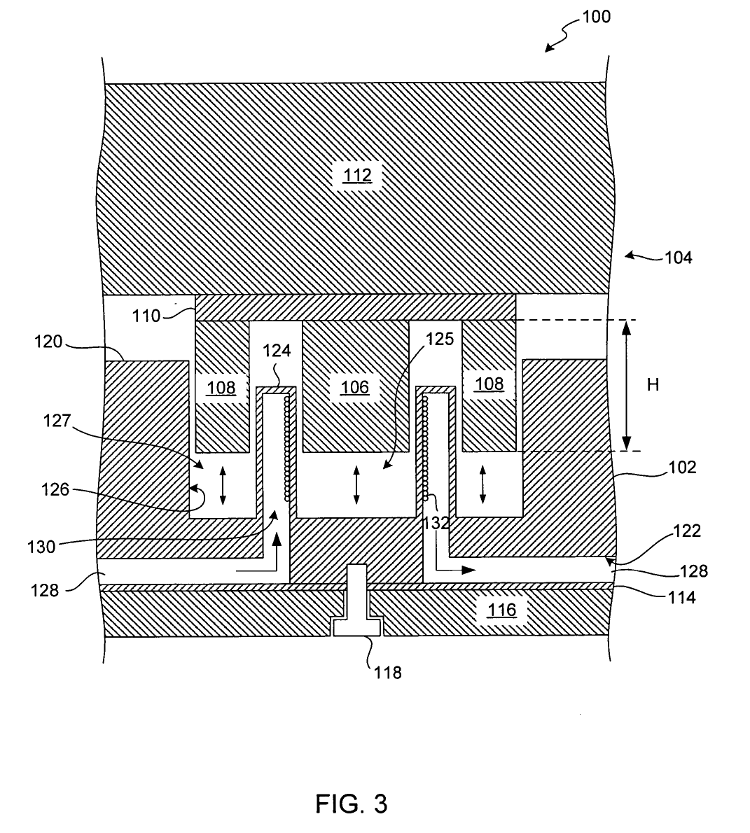

FIGS. 1-4 describe one embodiment of an actuator device 100 according to one embodiment of the present invention. FIG. 1 illustrates a top, perspective view of a base plate 102 that contains the actuator base 101 of multiple actuator devices, according to one embodiment of the invention. The dashed circular line in FIG. 1 indicates the actuator base 101 of one of the actuator devices 100. FIG. 2 illustrates a magnet assembly 104, wherein the actuator base 101 and magnet assembly 104, form actuator device 100 when mated together. FIG. 3 illustrates a side plan, cross-sectional view of actuator device 100 along line 3-3, as shown in FIG. 1, when actuator base 101 and magnet assembly 104 are mated with each other. FIG. 4 illustrates a perspective view of actuator base 101 from the underside of base plate 102.

As shown in FIG. 3, actuator device 100 generally includes magnet assembly 104 and base plate 102. Magnet assembly 104 includes magnet pieces 106 and 108, stand-off piece 110, and a workpiece 112. Magnet pieces 106 and 108 are attached to standoff piece 110, which is in turn attached to workpiece 112. Actuator device 100 also includes a gasket 114, a back plate 116, and a fastening device 118. Fastening device 118 secures gasket 114 and back plate 116 to base plate 102.

Base plate 102 can be made from a solid piece of material such as metal, a metal alloy, or ceramic. Base plate 102 has a top surface 120 and a bottom surface 122. Base plate 102 has multiple recessed regions within which are formed a rim 124 and an outer wall 126. Rim 124 defines a shaft 125, within which is positioned magnet 106. Outer wall 126 circles around rim 124 to define an annular region 127. Magnet 106, which is also annular in shape, is positioned within annular region 127. As seen in FIGS. 3 and 4, the bottom surface 122 of base plate 102 is shaped to have embedded channels 128 and a cavity 130. Cavity 130 is formed to fit within the thickness of inner rim 124 while channels 128 connect to cavity 130.

Electrically conductive wire loop 132 is positioned within cavity 130. Wire loop 132 is wrapped around the inner surface of cavity 130 such that wire loop 132 surround shaft 125. Wire loop 132 is connected to a voltage source (not shown) so that current flows through wire loop 132. Wire loop 132 generates and gives off heat as current runs through wire loop 132. Magnet piece 106 is sized to fit within inner rim 124 such that magnet piece 106 can freely move up and down within rim 124. In some embodiments, magnet piece 106 is shaped to conform to the shape of rim 124 such that magnet 106. In FIGS. 1, 2, and 3, magnet 106 is cylindrical. Magnet 108 has an annular shape and is sized to fit around the outer perimeter of rim 124. Since magnets 106 and 108 are both attached to standoff piece 110, magnets 106 and 108 are free to move in unison in an up and down motion with respect to rim 124. Outer wall 126 surrounds magnet 108. Standoff piece 110 is then connected to workpiece 112.

Magnets 106 and 108 work together to create a magnetic field that passes through rim 124, cavity 130, and wire loop 132. For instance, magnet 106 can have a positive polarity and magnet 108 can have a negative polarity, or vice-versa. As is commonly understood, the interaction between the magnetic field and the current passing through wire loop 132 creates a force, such as a Lorentz force, which is used to either push or pull on workpiece 112. Using such a force allows actuator device 100 to move, position, stabilize, or shape workpiece 112.

Actuator device 100 is designed so that coolant fluid flows through channels 128 and cavity 130 and over wire loop 132. As shown by the directional arrows in FIGS. 3 and 4, coolant fluid travels through passageway 128 towards cavity 130, enters and passes through cavity 130, and then leaves cavity 130 through passageway 128, which is also connected to an opposite end of cavity 130. The coolant fluid removes the heat generated by wire loop 132 and then exits cavity 130. The coolant fluid, which is heated by wire loop 132, then flows out of cavity 130. Gasket 114 and back plate 116 are attached to bottom surface 122 of base plate 102 in order to seal passageways 128 and cavity 130.

Rim 124 is hollow since cavity 130 extends into the body of rim 124. Rim 124 is tube shaped and cavity 130 has a corresponding tube shape that fits within rim 124. In alternative embodiments, rim 124 can have a variety of shapes such as rectangular, square, or oval. In such embodiments, cavity 130 can also conform to the shape of rim 124. In the embodiment shown in FIGS. 1-4, a single magnet 106 and magnet 108 form a pair of magnets surrounding rim 124. In alternative embodiments however, multiple magnets 106 and 108 can be utilized to form multiple pairs of magnets that each sandwich a portion of rim 124.

The height of rim 124, that is the height to which rim 124 extends from the bottom of shaft 125 and annular region 127, depends upon specific actuator design requirements. For instance, an actuator that requires a wire loop 132 having a large number of loops may require a rim 124 that has a larger height. Alternatively, rim 124 could be formed to have a larger thickness so that cavity 130 would also have a larger thickness. In this way, a larger wire loop 132 can be inserted into cavity 130. The larger thickness of cavity 130 would then be able to accommodate the larger thickness of wire loop 132.

Wire loop 132 is wrapped around the inner surface of cavity 130 in a single layer or in multiple layers. Cavity 130 should be sized so that sufficient room is given for coolant fluid to pass over wire loop 132 and to remove heat generated by wire loop 132. As seen in FIGS. 3 and 4, coolant fluid flows into cavity 130 from the bottom surface 122 of base plate 102, flows through cavity 130, and then out of cavity 130. As is more specifically shown in FIG. 4, the coolant fluid can flow around each side of the circular cavity 130. That is, the coolant fluid can flow around cavity 130 in two semi-circular paths. As is more specifically shown in FIG. 3, the coolant fluid also flows up into cavity 130 and then back down upon exiting cavity 130.

A coolant fluid source and sink (not shown) are connected to opposite ends of channel 128 of FIG. 3 to pump the fluid through channel 128. In one embodiment, the coolant fluid passes through a cooling system so that the coolant fluid can be reused to remove heat from wire loop 132.

Channels 128 are formed in the bottom surface 122 of base plate 102. Channels 128 are recessed pathways for the passage of coolant fluid. Channels 128 become enclosed conduits after gasket 114 is attached to the bottom surface 122 of base plate 102. Coolant fluid can flow through channel 128, which is sealed between base plate 102 and gasket 114, without leakage. This is advantageous in that surrounding devices and operational environments will not be affected. As seen in FIGS. 3 and 4, channel 128 joins with cavity 130 at opposite ends of the circular outline of cavity 130. In this configuration, coolant fluid can flow into one end of cavity 130 and then flow out of the opposite end of cavity 130. In alternative embodiments, channel 128 can join with cavity 130 at various points along cavity 130. For example, channel 128 can lead into and out of cavity 130 at positions adjacent to each other. Channels 128 can be formed to have various depths and widths to allow for a range of flow rates.

Magnets 106 and 108 have a height, H, which allows the magnets to extend along the height of wire loop 132. In this way, magnets 106 and 108 can create a magnetic field that encompasses all of the wire loops. In alternative embodiments, however, the height H of magnets 106 and 108 can be larger or smaller than the height of wire loop 132. Generally, magnets 106 and 108 will have approximately the same height, H. The surface of base plate 102 in the regions beneath magnets 106 and 108 and inside and outside of rim 124 are approximately co-planar and allow magnets 106 and 108 to extend to the point where wire loop 132 is completely sandwiched between the magnets.

Workpiece 112 is an object connected to actuator device 100 through standoff piece 110. Actuator device 100 can be used to position, move, and/or shape workpiece 112. For instance, workpiece 112 can be attached to actuator device 100, which acts like a suspension system that minimizes vibrations absorbed by workpiece 112. Workpiece 112 can be a complex mechanical device or a simple mechanical structure. For example, workpiece 112 can be a mirror that can be positioned by actuator device 100. Such a mirror could be used by an extreme ultra-violet (EUV) photolithography system for the purposes of exposing a substrate with specific patterns of light. Actuator device 100 can also be used to apply force to a small region of a mirror so that controlled deformation of the mirror is useful in fine-tuning the shape of the mirror.

Standoff piece 110 is an optional component that joins workpiece 112 to magnets 106 and 108. Standoff piece 110 creates a standoff distance between magnets 106 and 108, and workpiece 112. Standoff piece 110 also creates a desired standoff distance between base plate 102 and workpiece 112. Standoff piece 110 can be sized according to the desired standoff distance required between workpiece 112 and magnets 106 and 108 and base plate 102.

In some embodiments of the invention, standoff piece 110 can be a part of the “magnetic circuit” created by magnets 106 and 108. This means that standoff piece 110 can be formed of a material that guides the electromagnetic fields created by magnets 106 and 108. In such an embodiment, standoff piece 110 can be referred to as a yoke. In some embodiments, standoff piece or yoke 110 has downward extending portions that attach to each of magnets 106 and 108.

Magnets 106 and 108, standoff piece 110, and workpiece 112 can be attached to each other in a variety of manners. For example, these components can be attached to each other using adhesive epoxy, mechanical fastners, or brazing.

Gasket 114 can be a flat sheet of material that covers the entire bottom surface 122 of base plate 102 or it can be shaped to fit around channels 128 only. Gasket 114 can be made of rubber or soft metal such as indium. Back plate 116 secures gasket 114 onto the bottom surface 122 of base plate 102. Back plate 116 can be made of steel, aluminum, silicon carbide. Fastner device 118 can be, for example, a screw or a bolt. Fastner device 118 inserts through back plate 116 and gasket 114 in order to secure the two components to base plate 102.

In an alternative embodiment, base plate 102 can be formed such that some of the base plate material between each of actuator bases 101 can be removed. The resulting base plate would be thinner in the regions between the actuator bases 101. Also outer wall 126 would have a thickness such that outer wall 126 would be on the inner surface of a larger rim that surrounds annular region 127. In other embodiments, outer wall 126 and the larger rim that supports outer wall 126 can be omitted from base plate 102. Note that the base plate material between actuator bases 101 of FIG. 1 provide added thickness to base plate 102 and thereby increase the stiffness of base plate 102.

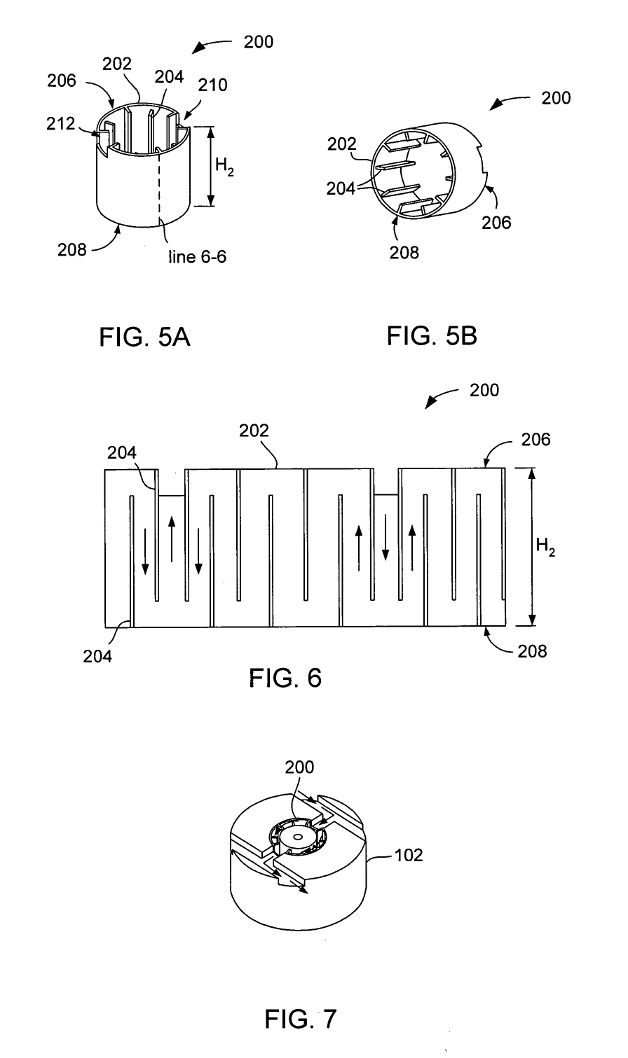

To efficiently utilize the heat removing capabilities of the coolant fluid, a flow guide can be inserted into cavity 130 of actuator device 100. FIGS. 5A-7 illustrate a flow guide 200 according to one embodiment of the invention. FIGS. 5A and 5B illustrate perspective views of flow guide 200 along two different angles. FIG. 6 illustrates flow guide 200 in its unrolled configuration after being “cut open” along line 6-6 as seen in FIG. 5A. FIG. 7 illustrates flow guide 200 after it has been inserted into cavity 130 of actuator device 100.

Flow guide 200 includes a shell 202 and multiple vanes 204 that extend from shell 202. Shell 202 has a tube shape and a height, H₂. Vanes 204 are elongated, flat panels that extend from the interior surface of shell 202 and radially towards the center of shell 202. Vanes 204 run along the height, H₂, of shell 202. As seen in its unrolled configuration in FIG. 6, vanes 204 are spaced apart from each other and aligned along a top end 206 and a bottom end 208 in an alternating pattern. In this configuration, the vanes create a winding path around shell 202. Shell 202 has openings 210 and 212 formed at opposite ends of the circular shape of shell 202. In alternative embodiments, some or all of vanes 204 are positioned at a vertical height such that each vane 204 is offset from both the top end 206 and the bottom end 208. These vanes guide coolant fluid vertically through cavity 130, however they do not necessarily force coolant fluid through a winding pathway.

As seen in FIG. 7, when flow guide 200 is inserted into cavity 130, shell 202 conforms to the outer surface of cavity 130 and vanes 204 extend towards the inner surface of cavity 130. Vanes 204 do not extend all the way to the inner surface of cavity 130 to accommodate for wire loop 132 that is wrapped within cavity 130. Vanes 204 can extend from shell 202 until vanes 204 come into contact with or almost come into contact with wire loop 132. Openings 210 and 212 are aligned with channels 128 at the points at which channels 128 join with cavity 130. Openings 210 and 212 allow for coolant fluid to flow into and out of cavity 130 from channels 128. Meanwhile, vanes 204 are configured to guide coolant fluid to flow through cavity 130 in two semi-circular paths while traveling up and down along the height, H₂, of cavity 130. Directional arrows in FIGS. 6 and 7 illustrate the flow pattern of coolant fluid through flow guide 200. Flow guide 200 guides coolant fluid over substantially all of wire loop 132 so that heat can be effectively removed from all portions of wire loop 132.

Shell 202 and vanes 204 can be integrally formed such that flow guide 200 is made of a single piece of material. Alternatively, shell 202 and vanes 204 can be separate components that are attached to each other. Flow guide 200 can be made from various materials such as but not limited to Teflon® and Delrin®.

Alternative embodiments of flow guide 200 can embody different vane 204 configurations so that different flow patterns are created within cavity 130. Also, vanes 204 can be spaced differently to adjust the width of the pathways of flow guide 200 and the distance through which coolant fluid travels through flow guide 200.

To match the locations of channels 128 in base plate 102, openings 210 and 212 can be positioned about various locations on the perimeter of shell 202: In this way openings 210 and 212 can properly allow for coolant fluid to flow into and out of cavity 130.

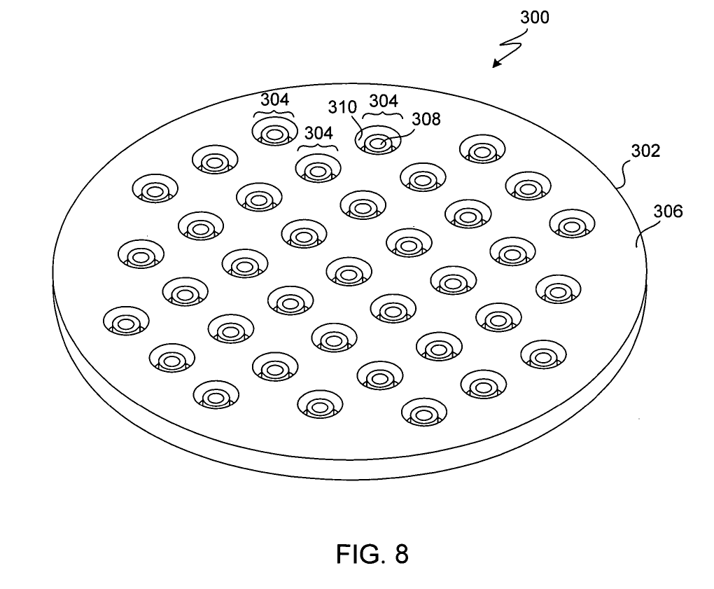

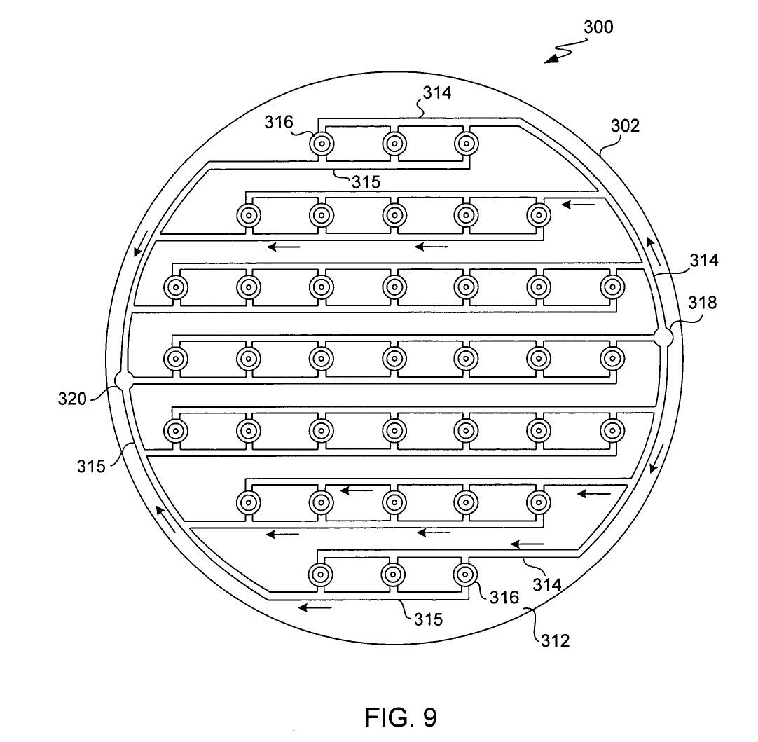

FIGS. 8 and 9 illustrate an electromagnetic actuator array 300 according to an alternative embodiment of the invention. FIG. 8 illustrates a perspective view of a top surface 306 of actuator array 300, and FIG. 9 illustrates a bottom plan view of a bottom surface 312 of actuator array 300. Actuator array 300 includes a base plate 302 that has multiple actuator bases 304. Each actuator base 304 is similar to actuator base 101 as described in FIGS. 1-4. As seen in FIG. 8, each actuator 304 includes a rim 308 and an outer wall 310. And as seen in FIG. 9, each actuator base 304 also includes channels 314 and 315 and cavities 316 that are formed in the bottom surface 312 of base plate 302. One set of channels, inlet channels 314, are each connected to a coolant inlet 318. Another set of channels, outlet channels 315, are each connected to coolant outlet 320. Again, each cavity 316 is formed within a respective rim 308.

Coolant inlet 318 introduces coolant fluid into each of inlet channels 314. Coolant channels branch out from coolant inlet 318 so that they pass by and connect to the cavities 316 of each actuator base 304. Each inlet channel 314 terminates at the last cavity 130 into which the inlet channel 314 connects. Inlet channels 314 allow coolant fluid to be fed into each of cavities 316 so that wire loops within the cavities 316 can be cooled. Outlet channels 315 are connected to each of cavities 316 so that coolant fluid that is injected into each of cavities 316 can also exit the same cavities. Each of outlet channels 315 lead to coolant outlet 320. Coolant inlet 318 and coolant outlet 320 maintain a flow of low temperature coolant fluid within cavities 316. Inlet channels 314 and outlet channels 315 are shown in FIG. 9 to connect to opposite sides of each cavity 316. In alternative embodiments, however, inlet channels 314 and outlet channels 315 can connect to various points along cavities 316 so long as coolant fluid can be circulated into and out of each cavity 316.

Inlet channels 314 and outlet channels 315 can also be patterned to follow various paths along the bottom surface of base plate 302 while connecting to each of cavities 316. Channels 314 and 315 can also be connected to various numbers of cavities 316 in order to maintain a certain flow rate or coolant fluid pressure within each cavity 316. For example, each inlet channel 314 can be joined to fewer cavities 316 in order to maintain a sufficiently high fluid pressure within each cavity 316.

Actuator bases 304 are aligned along rows and columns; however, the specific arrangement can vary depending upon specific design requirements. For example, actuator bases 304 can be positioned according to various geometric shapes and/or at specific locations about base plate 302 in order to conform to the shape of a workpiece that is connected to each of actuator bases 304. Base plate 302 can also be formed such that its top surface 306 lies in multiple planes. For instance, base plate 302 can bend along an x-axis so that top surface 306 lies in the horizontal plane and a perpendicular, vertical plane. In this way, actuator bases 304 can connect to and position a workpiece in both the horizontal and vertical axes.

Not shown in FIG. 8 are each of the magnet assemblies that would fit into each actuator base 304. Each of the magnet assemblies could move independently or in unison to position, move, stabilize, and/or shape a workpiece that would be attached to each of the magnet assemblies.

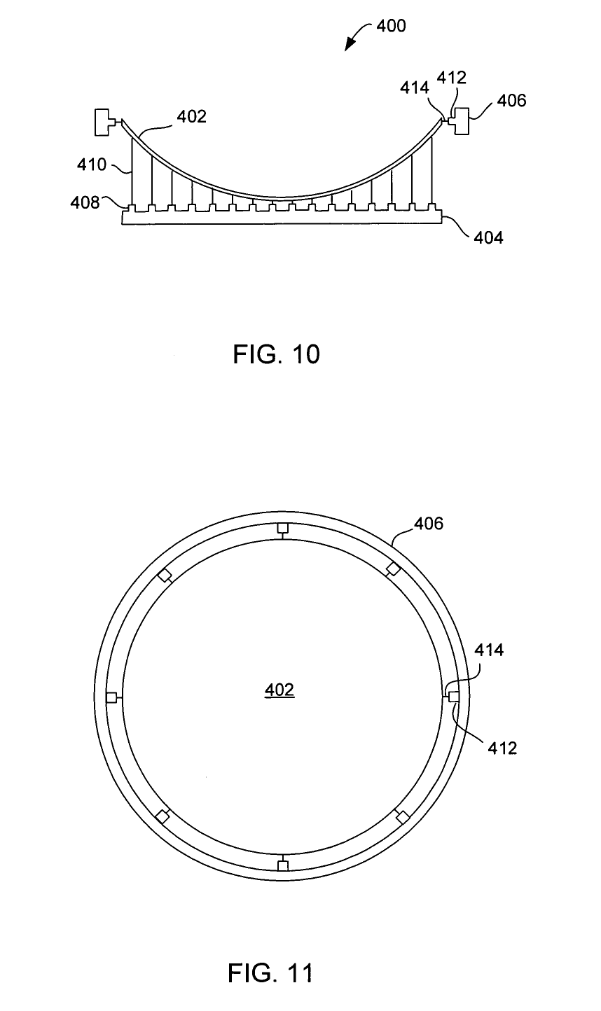

FIGS. 10 and 11 illustrate an example of a workpiece that is attached to actuators. Specifically, FIG. 10 illustrates a side plan view of an actuator system 400 that includes workpiece 402 that is attached to a vertical electromagnetic actuator array 404 and a horizontal electromagnetic actuator array 406 according to one embodiment of the invention. FIG. 11 illustrates a top plan view of actuator system 400.

Vertical electromagnetic actuator array 404 includes an array of electromagnetic actuators 408. Each of actuators 408 applies forces to workpiece 402 in a vertical direction in either the upward or downward direction. Each actuator 408 has a similar structure to that shown for actuator 100 as shown in FIG. 1 in that each actuator 408 has electrically conductive wires wrapped within a cavity and a pair of magnets that sandwich the wires. Each actuator 408 is connected to workpiece 402 directly or through a shaft 410. Actuators 408 can act together to position workpiece 402 in a desired orientation. Actuators 408 can also act independently to deform the shape of workpiece 402 in a controlled manner. The amount of deformation is used to adjust the shape of workpiece 402 to a specific desired shape. For example, when workpiece 402 is a mirror, actuators 408 fine-tune the shape of the mirror so that a desired optical geometry can be achieved.

Horizontal electromagnetic actuator array 406 includes an array of electromagnetic actuators 412, which apply forces to object 402 in the horizontal plane. Array 406 has a circular shape that conforms to the outer circumference of workpiece 402. The circular shape of array 406 allows each of actuators 412 to be attached to workpiece 402 through connecting rods 414. In alternative embodiments, actuators 412 can also be directly attached to workpiece 402. Horizontal electromagnetic actuator array 406 can position, move, and/or shape workpiece 402. Each of actuators 412 can act together or independently.

In alternative embodiments, workpiece 402 can have various shapes. For instance, workpiece 402 could be a flat or convex shaped mirror. In each of these embodiments, the shape of horizontal array 404 and vertical array 406 can conform to the shape of workpiece 402 so that each of the respective actuators can be connected to workpiece 402.

In yet other embodiments, each of horizontal and vertical arrays 404 and 406 can be arranged in various orientations so that actuators apply forces to workpiece 402 in those respective orientations. In other words, actuator arrays 404 and 406 need not apply forces to workpiece 402 in strictly horizontal and vertical directions.

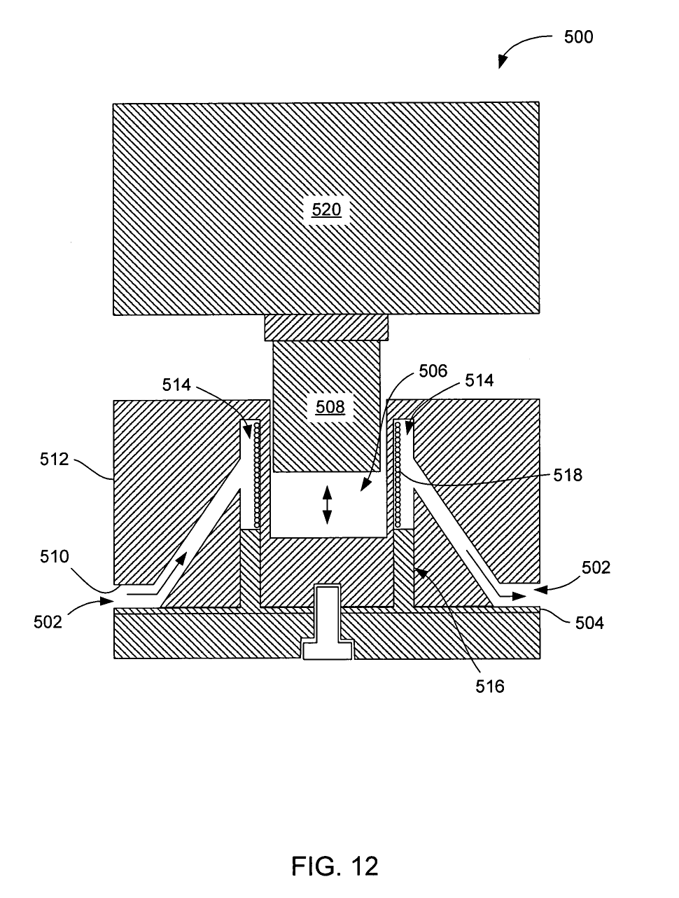

FIG. 12 illustrates a side plan, cross-sectional view of an actuator device 500 according to an alternative embodiment of the present invention. Actuator device 500 differs from actuator device 100 of FIG. 3 in that actuator device 500 has a single shaft 506 into which a single magnet 508 inserts. Actuator device 500 also differs in that the path taken by channels 502 and the shape of gasket 504. Channels 502 are formed in the bottom surface 510 of base plate 512 however, channels 502 bend upwards so that channels 502 burrow beneath the surface of bottom surface 510. Channels 502 run within the body of base plate 512 until they join with cavity 514 at a point beneath bottom surface 510. Gasket 504 is shaped so that it has an insert 516 that fits into cavity 514.

Channels 502 connect to a point between the upper and lower points of cavity 514. In this way, coolant fluid that flows through channels 520 enter and exit cavity 514 at points that are directly adjacent to electrical wires 518. This channel configuration can be advantageous because coolant fluid is injected directly onto electrical wires 518. When the height of electrical wires 518 is small, then the entry point of coolant fluid into cavity 514 allows the coolant fluid to flow over a substantial portion of wires 518. In this way, coolant fluid can sufficiently remove heat from electrical wires 518 without the need for a flow guide to guide coolant fluid over each portion of wires 518. However, a flow guide can still be inserted into cavity 514 to guide the flow of coolant fluid through cavity 514 and over wires 518.

Insert 516 of gasket 504 inserts into cavity 514 in order to seal cavity 514 from the bottom side. In this way, coolant fluid is prevented from leaking out of cavity 514. As shown in FIG. 12, insert 516 extends upwards until it makes contact with wires 518. Insert 516 directs coolant fluid around wires 518. Insert 516 is integrally formed with gasket 504 however in alternative embodiments, insert 516 and gasket 504 can be separate components. Note that coil 518 should be substantially fixed to the inner surface of cavity 514 in order to maintain accuracy of positioning magnet 508.

Actuator device 500 uses a single magnet 506 that imposes a magnetic field to flow through wires 518. The interaction of the magnetic field and electrical current that flows through wires 518 creates a force, such as a Lorentz force, that moves magnet 506 and object 520 along the vertical axis.

An array of electromagnetic actuator devices 500 can be formed in a structure similar to that shown in FIGS. 8 and 9. Such an array can also move, position and shape an object in a similar manner shown in FIGS. 10 and 11. An array of actuator devices can have a combination of actuator devices as shown in FIGS. 1 and 12.

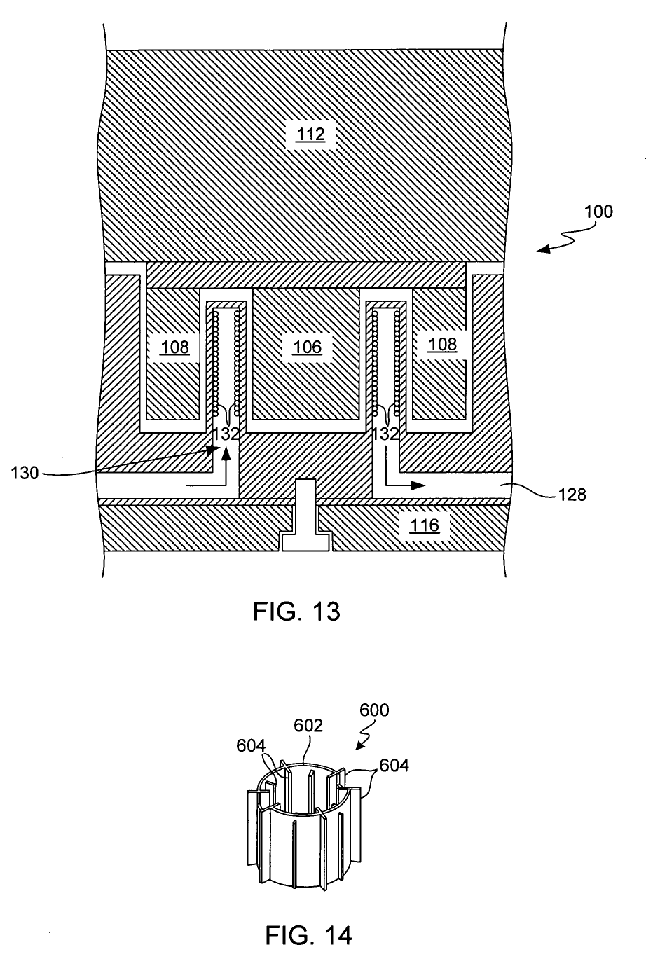

FIG. 13 illustrates actuator device 100 of FIG. 3 wherein wire loops 132 are wrapped along both the inner and outer walls of cavity 130. The additional wire loop 132 within cavity 130 allow for a larger force created by the interaction between the electrical current flowing within wire loop 132 and magnets 106 and 108. This in turn provides for larger actuator forces than can position a heavier workpiece 112, move workpiece 112 at a higher speed, or utilize more force when shaping the surface of workpiece 112.

FIG. 14 illustrates a perspective view of a flow guide 600 according to an alternative embodiment of the present invention. Flow guide 600 includes a shell 602 and multiple vanes 604 that extend from both the inner and outer surface of shell 602. Flow guide 600 can be inserted into cavity 130 of actuator 100 in FIG. 13 in order to guide coolant fluid over wire loops 132, which are on both the inner and outer surfaces of cavity 130. Vanes 604 can alternate in vertical alignment as described in FIGS. 5A, 5B, and 6 in order to guide coolant fluid through cavity 130 in a winding pattern.

An alternative embodiment of the electromagnetic actuator device includes a solid base plate wherein a top surface of the base plate has a lengthwise ridge. Within the ridge is a cavity that contains electrically conductive coils. A bottom surface of the base plate contains embedded channels that connect to the cavity so that coolant fluid can flow through the channels and the cavity in order to remove heat from the coils. A magnet assembly having opposing magnetic poles is positioned over the ridge so that the magnet sandwiches the ridge. The magnet assembly and the coils interact to create an electromagnetic force, which moves the magnet assembly with respect to the ridge. The solid base plate can prevent leakage of the coolant fluid, which could cause damage to an operating system or environment.

While this invention has been described in terms of several preferred embodiments, there are alteration, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. An electromagnetic motor apparatus comprising:
a solid base plate having a first surface and an opposing second surface, a rim formed on the first surface of the base plate wherein the rim is integrally formed with the base plate;
a recessed channel formed on the second surface of the base plate, the channel having an inlet end and an outlet end;
a cavity formed within the second surface of the base plate, the cavity also extending into the rim such that the rim is substantially hollow, the cavity being connected to the channel whereby a fluid can enter the channel at the inlet end, flow through the channel and the cavity, and then exit the channel at the outlet end; and
a plurality of conductive wires positioned within the cavity whereby the fluid can pass over the wires and thereby remove heat from the wires.

2. An electromagnetic motor apparatus as recited in claim 1 further comprising:
a pair of magnets positioned adjacent to the first surface of the base plate and such that the rim is positioned between the pair of magnets whereby the pair of magnets create a magnetic field that passes through the rim and the conductive wires.

3. An electromagnetic motor apparatus as recited in claim 2 wherein the pair of magnets maintain separation from the rim such that a force created by the interaction between a current that runs through the conductive wires and the magnetic field causes movement between the pair of magnets and the rim.

4. An electromagnetic motor apparatus as recited in claim 1 wherein the rim has a ring-shaped outline such that the rim extends from the base plate in the shape of a tube wherein the rim defines a shaft.

5. An electromagnetic motor apparatus as recited in claim 4 wherein the cavity has a cylindrical shape that corresponds to the shape of the rim.

6. An electromagnetic motor apparatus as recited in claim 5 wherein the conductive wires are wrapped around an inner surface of the cavity.

7. An electromagnetic motor apparatus as recited in claim 4 further comprising:
a first magnet positioned within the shaft of the rim; and
a second magnet having a tube shape that is sized to fit around the tube-shaped rim wherein the diameter of the second magnet is larger than the diameter of the rim whereby the first and second magnets create a magnetic field that passes through the rim and the conductive wires.

8. An electromagnetic motor apparatus as recited in claim 3 wherein the rim is straight.

9. An electromagnetic motor apparatus as recited in claim 1 wherein the channel and the cavity connect to each other on the second surface of the base plate.

10. An electromagnetic motor apparatus as recited in claim 1 wherein at least one segment of the channel burrows beneath the second surface of the base plate to a depth between the first and second surfaces.

11. An electromagnetic motor apparatus as recited in claim 10 wherein the channel and the cavity connect to each other beneath the second surface of the base plate at a point between the first and second surfaces.

12. An electromagnetic motor apparatus as recited in claim 1 further comprising:
a gasket that covers second surface of the base plate such that the channel and cavity are sealed between the base plate and the gasket.

13. An electromagnetic motor apparatus as recited in claim 1 further comprising:
a flow guide positioned within the cavity and configured to guide the flow of fluid throughout the volume of the cavity.

14. An electromagnetic motor apparatus as recited in claim 5 further comprising:
a flow guide that fits within the cavity, the flow guide including a tube-shaped shell with a plurality of vanes that extend from an inner surface of the shell in a radial direction towards the center of the shell, each vane also extending along the longitudinal axis of the shell, whereby the flow guide guides the flow of fluid throughout the volume of the cavity.

15. An electromagnetic motor apparatus as recited in claim 14 wherein the tube-shaped shell of the flow guide has a first end and a second end along the longitudinal axis and wherein a first set of the vanes are aligned with the first end of the shell and a second set of the vanes are aligned with the second end of the shell, wherein each vane of the second set is positioned between a vane of the first set such that the vanes alternate in being aligned with the first and second ends of the shell, whereby the flow guide guides fluid throughout the cylindrically-shaped cavity.

16. An electromagnetic motor apparatus as recited in claim 14 further comprising a third and a fourth set of vanes that extend from an outer surface of the shell in a radial direction, each vane also extending along the longitudinal axis of the shell, the third set of the vanes being aligned with the first end of the shell and the fourth set of vanes being aligned with the second end of the shell, wherein each vane of the third set is positioned between a vane of the fourth set such that the vanes alternate in being aligned with the first and second ends of the shell.

17. An electromagnetic motor apparatus as recited in claim 16 wherein a first set of the conductive wires are wrapped around an inner surface of the cavity and a second set of the conductive wires are wrapped along the outer surface of the cavity.

18. An electromagnetic motor apparatus as recited in claim 3 further comprising:
a mirror wherein a portion of the mirror is connected to the pair of magnets such that the movement of the magnets with respect to the rim allows the electromagnetic motor apparatus to adjust the shape of the mirror.

19. An electromagnetic motor apparatus as recited in claim 4 wherein the rim extends from a recessed portion of the first surface of the base plate such that at least a portion of the height of the rim is located beneath the first surface of the base plate.

20. An electromagnetic motor apparatus comprising:
a solid base plate having a first surface and an opposing second surface, a shaft formed within the first surface of the base plate;
a recessed channel formed on the second surface of the base plate, the channel having an inlet end and an outlet end;
a cavity formed within the second surface of the base plate, the cavity surrounding and conforming to an outline of the shaft, the cavity being connected to the channel whereby a fluid can enter the channel at the inlet end, flow through the channel and the cavity, and then exit the channel at the outlet end; and
a plurality of conductive wires positioned within the cavity whereby the fluid can pass over the wires and thereby remove heat from the wires.

21. An electromagnetic motor apparatus as recited in claim 20 further comprising:
a magnet positioned within the shaft of the base plate wherein the magnet maintains separation from a surface of the shaft whereby the magnet creates a magnetic field that passes through the cavity and the conductive wires such that a force created by the interaction between a current that runs through the conductive wires and the magnetic field causes movement between the magnet and the shaft.

22. An electromagnetic motor apparatus as recited in claim 21 wherein the shaft, cavity, and magnet have circular outlines.

23. An electromagnetic motor apparatus as recited in claim 20 wherein at least one segment of the channel burrows beneath the second surface of the base plate to a depth between the first and second surfaces.

24. An electromagnetic motor apparatus as recited in claim 21 wherein the channel and the cavity connect to each other beneath the second surface of the base plate at a point between the first and second surfaces.

25. An electromagnetic motor apparatus as recited in claim 20 further comprising:
a gasket that covers second surface of the base plate such that the channel and cavity are sealed between the base plate and the gasket.

26. An electromagnetic motor apparatus comprising:
a solid base plate having a first surface and an opposing second surface, a plurality of rims formed on the first surface of the base plate wherein each rim is integrally formed with the base plate;
a plurality of recessed channels formed on the second surface of the base plate, each channel having an inlet end and an outlet end;
a plurality of cavities formed within the second surface of the base plate, each cavity extending into a respective rim such that each rim is substantially hollow, each cavity being connected to one of the channels whereby a fluid can enter one of the channels at the inlet end, flow through the channel and one of the cavities, and then exit the channel at the outlet end; and
a plurality of conductive wires positioned within each cavity whereby the fluid can pass over the wires and thereby remove heat from the wires.

27. An electromagnetic motor apparatus as recited in claim 26 wherein each rim has a ring-shaped outline such that each rim extends from the base plate in the shape of a tube wherein each rim defines a shaft.

28. An electromagnetic motor apparatus as recited in claim 27 wherein each rim extends from a respective recessed portion of the first surface of the base plate such that at least a portion of the height of each rim is located beneath the first surface of the base plate.

29. An electromagnetic motor apparatus as recited in claim 27 wherein each cavity has a cylindrical shape that corresponds to the shape of each rim.

30. An electromagnetic motor apparatus as recited in claim 27 further comprising:
a plurality of magnet pairs that include a first and a second magnet, each first magnet positioned within the shaft of a respective rim, and each second magnet having a tube shape that is positioned around a respective tube-shaped rim wherein the diameter of the second magnets is larger than the diameter of the rims, each magnet pair creating a magnetic field that passes through a respective rim and conductive wires, whereby a force is created by the interaction between a current that runs through the conductive wires and the magnetic field thereby causing movement between each magnet pair and each respective rim.

31. An electromagnetic motor apparatus as recited in claim 30 further comprising:
a mirror wherein each magnet pair is connected to a respective portion of the mirror such that the movement of the magnets allows the electromagnetic motor apparatus to adjust the shape of the mirror.

32. An electromagnetic motor apparatus as recited in claim 30 wherein at least one magnet pair moves along each of an x-axis, a y-axis, and a z-axis, the electromagnetic motor apparatus further comprising:
a mirror wherein at least one magnet pair that moves along each of the x, y, and z-axes is connected to the mirror such that the magnet pairs can adjust the orientation of the mirror in six degrees of freedom.

33. An electromagnetic motor apparatus as recited in claim 26 further comprising:
a gasket that covers second surface of the base plate such that each of the channels and cavities are sealed between the base plate and the gasket.

34. An electromagnetic motor apparatus as recited in claim 26 further comprising:
a plurality of flow guides wherein each flow guide fits within a respective cavity, each flow guide including a tube-shaped shell with a plurality of vanes that extend from an inner surface of the shell in a radial direction towards the center of the shell, each vane also extending along the longitudinal axis of the shell, whereby each flow guide guides the flow of fluid throughout the volume of the cavity.

35. A lithography system comprising:
an illumination source;
an optical system;
a reticle stage arranged to retain a reticle;
a working stage arranged to retain a workpiece;
an enclosure that surrounds at least a portion of the working stage, the enclosure having a sealing surface; and
an electromagnetic motor apparatus that includes,
a solid base plate having a first surface and an opposing second surface, a plurality of rims formed on the first surface of the base plate wherein each rim is integrally formed with the base plate;
a plurality of recessed channels formed on the second surface of the base plate, each channel having an inlet end and an outlet end;
a plurality of cavities formed within the second surface of the base plate, each cavity extending into a respective rim such that each rim is substantially hollow, each cavity being connected to one of the channels whereby a fluid can enter one of the channels at the inlet end, flow through the channel and one of the cavities, and then exit the channel at the outlet end; and
a plurality of conductive wires positioned within each cavity whereby the fluid can pass over the wires and thereby remove heat from the wires.

36. An object manufactured with the lithography system of claim 35.

37. A wafer on which an image has been formed by the lithography system of claim 35.

38. A method for making an object using a lithography process, wherein the lithography process utilizes a lithography system as recited in claim 35.

39. A method for patterning a wafer using a lithography process, wherein the lithography process utilizes a lithography system as recited in claim 35.
